(19) United States
(12) Patent Application Publication
(10) Pub. No.: US 2006/0059040 A1
(43) Pub. Date: Mar. 16, 2006

(54) Systems and methods of data transfer in a distributed computer network

(75) Inventors: Eric Eldred, Parker, CO (US); Terra Geiger, Denver, CO (US); Erik Crawford, Parker, CO (US); David Baumgartner, Parker, CO (US); Karen Larsen, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/927,629

(22) Filed: Aug. 25, 2004

(51) Int. Cl. G06Q 30/00

(52) U.S. Cl. 705/14

(57) ABSTRACT

A method of transporting electronic data in a distributed computer network, where the method includes receiving, at a first network node, a first data packet that includes a network event identifier, a user account identifier, and network event data, where the user account identifier points to a location on the first network node where the user account is stored, and the network event data define an operation between a user and a network operator. The method also includes processing the network event parameters with a loyalty algorithm to generate a loyalty value parameter; and calculating an updated account value parameter for the user account using the loyalty value parameter.

### CROSS-REFERENCES TO RELATED APPLICATIONS

This application is related to U.S. patent application Ser. No. 10/740,378, entitled “SYSTEMS AND METHODS FOR INTEGRATING LOYALTY AND STORED-VALUE PROGRAMS,” filed Dec. 17, 2003 by Colleen George and John Cawthore, the entire contents of which is herein incorporated by reference for all purposes. This application is also related to U.S. patent application Ser. No. 10/079,927, entitled “SYSTEMS AND METHODS FOR OPERATING LOYALTY PROGRAMS,” filed Feb. 19, 2002 by Colleen George and John Cawthorne, the entire disclosure of which is also incorporated herein by reference for all purposes. This application is further related to the following commonly assigned U.S. Patent Applications, the entire disclosure of each of which is also incorporated herein by reference for all purposes: U.S. patent application Ser. No. 09/971,303, entitled “STORED VALUE CARDS AND METHODS FOR THEIR ISSUANCE,” filed Oct. 3, 2001 by Kevin A. James et al.; U.S. patent application Ser. No. 10/371,167, entitled “METHODS AND SYSTEMS FOR COORDINATING A CHANGE 1N STATUS OF STORED-VALUE CARDS,” filed Feb. 21, 2003 by David R. Baumgartner; U.S. patent application Ser. No. 10/421,604, entitled “MULTI-PURSE CARD SYSTEM AND METHODS,” filed Apr. 22, 2003 by Kenneth Algiene; U.S. patent application Ser. No. 10/405,043, entitled “METHODS AND SYSTEMS FOR PROCESSING UNRESTRICTED STORED-VALUE INSTRUMENTS,” filed Mar. 31, 2003 by Christopher McGee and David R. Baumgartner; U.S. patent application Ser. No. 10/286,006, entitled “STORED VALUE CURRENCY CONVERSION SYSTEMS AND METHODS,” filed Nov. 1, 2002 by Kevin A. James et al.; U.S. patent application Ser. No. 10/356,207, entitled “ACH SETTLEMENT SYSTEMS AND METHODS,” filed Jan. 30, 2003 by David R. Baumgartner et al.; U.S. patent application Ser. No. 10/267,180, entitled “ELECTRONIC CARD AND TICKET AND METHODS FOR THEIR USE,” filed Oct. 8, 2002 by Christopher McGee et al.; U.S. patent application Ser. No. 10/268,040, entitled “DISCOUNT-INSTRUMENT METHODS AND SYSTEMS,” filed Oct. 8, 2002 by Christopher McGee et al.; and U.S. patent application Ser. No. 10/245,784, entitled “METHOD AND SYSTEM FOR MERCHANT PROCESSING OF PURCHASE CARD TRANSACTIONS WITH EXPANDED CARD TYPE ACCEPTANCE,” filed Sep. 17, 2002 by Allen C. Strayer et al.

### BACKGROUND OF THE INVENTION

This application relates generally to consumer transactions. More specifically, this application relates to operating integrated loyalty and stored value programs in connection with consumer transactions.

Probably the most important goal for every business is attracting and retaining customers. To this end, businesses have recognized the power of stored-value cards for attracting customers and loyalty programs for retaining them.

Stored value cards, such as gift cards, pre-paid promotional cards, pre-paid metered accounts associated with debits cards, etc. have been recognized by merchants as a good way to get consumers to by goods and services from their businesses. For example, gift cards may be purchased from various merchants such as Target®, Wal-Mart®, Starbucks®, Sears®, Blockbuster®, Macy's®, Banana Republic®, and the like. Pre-paid debit cards are also frequently purchased for telephone services. The purchase and usage of financial presentation instruments has continued to increase in recent years to the point that the sale of stored value cards, gift cards, and pre-paid debit cards today is a multi-billion dollar industry.

Loyalty programs are developed to give consumers an incentive to visit and return to the business. There are a wide variety of different models for loyalty programs, but a common feature of all is that they offer an incentive designed to encourage customers to conduct business preferentially with one organization rather than with competitor organizations. Such loyalty systems may take the form in which a consumer gets a free or discounted item after buying a certain number of items at the regular price. For example, restaurant businesses often issue stamp or punch cards to customers that can be turned in for a discounted or free meal after collecting predetermined number of stamps or punches. Unfortunately, it is inconvenient for businesses to track the customer utilization of the cards, or increase the variety and flexibility of the card program. Also, these systems are prone to fraud as the cards may be easily doctored to appear as if all the requisite stamps or punches are present.

Loyalty systems may also take the form of point systems in which a customer is credited with a number of points for each transaction and is entitled to exchange certain numbers of points for goods and/or services. An example of such a loyalty system is used in the airline industry. An airline typically offers some number of points to each consumer that is correlated with the distance traveled. At certain levels, the points may be exchanged by the consumer for airline tickets, and generally a larger number of points are required for more valuable international or intercontinental tickets. Similar loyalty systems are also used in businesses engaged in retail sales of goods, with customers of a particular store (or chain of stores) receiving points in exchange for certain levels of business.

The success of stored-value cards and loyalty programs focused the attention of businesses on the benefits of developing increasingly sophisticated, flexible and convenient transaction instruments for consumers. There is a general recognition by businesses that consumer are demanding more compatibility between different types of tender, and the ability use multiple types of tender (e.g., stored-value cards, loyalty program cards, credit cards, debit cards, store-coupons, etc.) for a transaction. Along with this compatibility, there is also recognition that consumers would prefer simplified transaction schemes that do not require the presentation of multiple financial instruments to receive the benefits of increasingly sophisticated transaction schemes. These and other problems are addressed by the present invention.

### BRIEF SUMMARY OF THE INVENTION

Embodiments of the invention include a method of transporting electronic data in a distributed computer network. The method includes receiving, at a first network node, a first data packet comprising a network event identifier, a user account identifier, and network event data. The user account identifier points to a location on the first network node where the user account is stored, and the network event data define an operation between a user and a network operator. The method also includes processing the network event parameters with a loyalty algorithm to generate a loyalty value parameter, and calculating an updated account value parameter for the user account using the loyalty value parameter.

Embodiments of the invention also include a method for operating an integrated stored-value and loyalty program. The method may include the steps of maintaining, at a host computer system, administration criteria for each of a plurality of distinct loyalty programs including the loyalty program and receiving, at the host computer system, a transaction identifier and a packet of transaction information defining a transaction between a merchant and a customer. The packet of transaction information may include one or more account identifiers, such as a stored-value account identifier and/or a loyalty program identifier. The method may further include determining a customer reward in accordance with the packet of transaction information and with the administration criteria for the loyalty programidentified by one of the account identifiers, and updating a stored-value account, identified in the host computer system by one of the account identifiers, with information from the customer reward.

Embodiments of the invention further include a method of conducting a transaction between a merchant and a customer using a stored-value account. The method may include the step of sending, to a transaction processing system, a transaction identifier and a packet of transaction information defining the transaction, where the packet of transaction information may include one or more account identifiers, such as a stored-value account identifier and/or a loyalty programidentifier. The method may also include receiving, at a point of sale device, customer reward information from the transaction processing system. The customer reward information may include a reward value for the transaction and an updated value amount of the stored-value account.

Additional features are set forth in part in the description that follows, and in part will become apparent to those skilled in the art upon examination of the following specification or may be learned by the practice of the invention. The features and advantages of the invention may be realized and attained by means of the instrumentalities, combinations, and methods particularly pointed out in the appended claims.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 provides a schematic illustration of the routing of transactional information in an integrated loyalty and stored-value program according to embodiments of the invention;

FIGS. 2A-2C provide schematic illustrations of how transaction information is routed in implementing both loyalty and stored-value programs according to embodiments of the invention;

FIG. 3 provides a schematic illustration of how information is processed by a stored-value host in implementing an embodiment of the invention;

FIG. 4 provides a flow diagram illustrating the operation of a loyalty host and a stored-value host in implementing certain embodiments of the invention;

FIG. 5A provides a schematic illustration of a computer system that may be configured to perform functions of the loyalty host and/or stored-value host in accordance with embodiments of the invention;

FIG. 5B provides a schematic illustration using a public-network connection to access the loyalty host and/or stored-value host in implementing program-management functions; and

FIGS. 6A and 6B provide flow diagrams illustrating some exemplary program-management functions that may be implemented with the loyalty host and/or stored-value host.

### DETAILED DESCRIPTION OF THE INVENTION

Embodiments of the present invention include systems and methods of operating an integrated stored-value and loyalty program in a financial infrastructure. This integration offers a customer the convenience of conducting transactions with a stored-value card (e.g., a gift card, pre-paid promotional card, etc.) that also allows the consumer to participate in one or more loyalty programs of a participating merchant. Customers may purchase or receive the stored-value card with a pre-loaded value and may purchase additional value through another tender (e.g., cash, check, credit card, etc.). Additional value may also accrue from customer rewards received from participation in a loyalty program associated with the card. Even after the customer has used all the value associated with the card (i.e., the stored value account associated with the card with the card has a value of zero) he or she may still use the card like a loyalty card that may accrue additional value from customer rewards generated by participation in the loyalty program. For example, a spent integrated stored-value/loyalty card for a restaurant chain may still act as an “electronic” punch card for a loyalty program where a customer reward in the form of a free meal may be added to the card.

Embodiments of the system of the present invention may include operating the integrated stored-value and loyalty program on a variety of electronic networks, including a private network coupling devices at points of sale to an integrated stored-value and loyalty program host, a conventional financial infrastructure such as one used to process credit-card transactions (e.g., the Visas and/or MasterCard® rails), and the Internet. Embodiments of systems of the present invention will now be described in more detail.

Integrated Loyalty and Stored-Value Systems

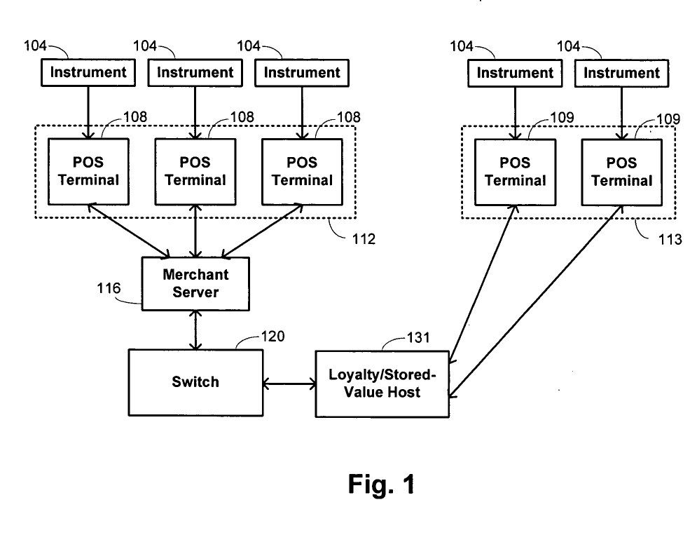

FIG. 1 shows a schematic illustration of the routing of transactional information in an integrated loyalty and stored-value program according to embodiments of the invention. In these embodiments, the transactional information may be transmitted on a private distributed computer network that includes one or more network nodes at the site of the transaction (e.g., point-of-sale (POS) terminals 108) that communicate with other network nodes on the distributed network (e.g., loyalty/stored value host 131). In some embodiments, additional network nodes such as merchant server 116, and switch element 120 may also be involved in the transport of data packets containing information about the transaction (e.g., a network event identifier, a user account identifier, network event data, etc.).

Generation of data packets is facilitated by a stored-value/loyalty instrument 104 that may be accepted by a POS terminal 108, 109. The stored-value/loyalty instrument 104 may be a magnetic-stripe card, a chip card (e.g., a smart card), an infrared data device (e.g., an IrDA device), a radio-frequency device, etc. that contains an account identifier that can associate the transaction with a stored-value account on the loyalty/stored value host 131.

POS terminals 108, 109 may be configured to accept different kinds of stored-value/loyalty instruments 104. The terminals may include payment-information-entry components, signature-capture components, keypads, keyboards, display screens, biometric-data-capture components, speakers, printers, processors, software, memory, communication devices, and the like. For example, the terminals may be configured to display information about the value of a customer reward received from the transaction and the updated value associated with the stored-value/loyalty card as well as a value for the transaction amount. The POS terminals 108, 109 may be in communication with a printing device (not shown) that prints this information on a receipt given to the customer.

In other embodiments (not shown), the customer may be able to obtain information about the transaction (as well as other transactions involving the stored-value/loyalty program) by using an electronic communications device (e.g., a desktop computer, laptop computer, a wireless handheld computing device like a PDA or cellphone, etc.) to access a website on the Internet. For example, a customer may be able to log on to a secure Internet website that displays information about the stored-value/loyalty program account such as an amount of loyalty points earned for each transaction, an accumulated loyalty point total, an updated value amount for a stored-value account, and a point threshold value for converting value points into cash value that is added to the stored-value account, among other information about the program account. The website may be interactive, and allow the customer to exchange loyalty points for a displayed set of goods and/or services. The website may also allow the customer to translate some portion (or all) of the currently accrued loyalty points into cash value for the stored-value program account. In other embodiments, the customer may be able to obtain and manage information about a stored-value/loyalty program account using a telephone.

Still other embodiments (not shown) the customer may receive printed statements in the mail about the stored-value/loyalty program account. The mailing may include, for example, a loyalty transaction report, a promotion report, an activation and activity report, and/or a loyalty point summary report, among other reports.

In the embodiment shown in FIG. 1, two sets of POS terminals (112 and 113) are shown that send electronic data to the loyalty/stored-value host 131 in different ways. A POS terminal 108 accepts stored-value/loyalty instruments 104 from a user (e.g., a customer) who is conducting a transaction with a network operator (e.g., a merchant). One or more data packets containing information about a network event (e.g., the transaction) may then be sent from POS terminal 108 to merchant server 116 that facilitates data communications between each POS terminal 108 in POS terminal set 112 and switch element 120. Switch element 120 may in turn coordinate transmissions between a plurality of merchant servers such as merchant server 116 and the loyalty/stored-value host 131.

Alternatively, as shown by POS terminal set 113, a direct connection may be formed between individual POS terminals 109 and the loyalty/stored-value host 131. In these embodiments, a POS terminal 109 accepts stored-value/loyalty instruments 104 from a user conducting a transaction with a network operator. One or more data packets containing information about a network event may then be sent from POS terminal 109 directly to loyalty/stored-value host 131.

POS terminals 109 and the loyalty/stored-value host 131 may communicate via, for example, a LAN, WAN, the Internet, or a dial-up connection, among other communications networks. For example, the POS terminals 109 may include a dial-up modem (not shown) to interface with the loyalty/stored value host 131 via a private financial telecommunications network, or a public telephone network. In other examples, the POS terminals 109 may be connected to a dial network interface (not shown) that includes a dialer and modem for establishing a communications link between the terminals 109 and host 131 using a private communications network or public telephone network.

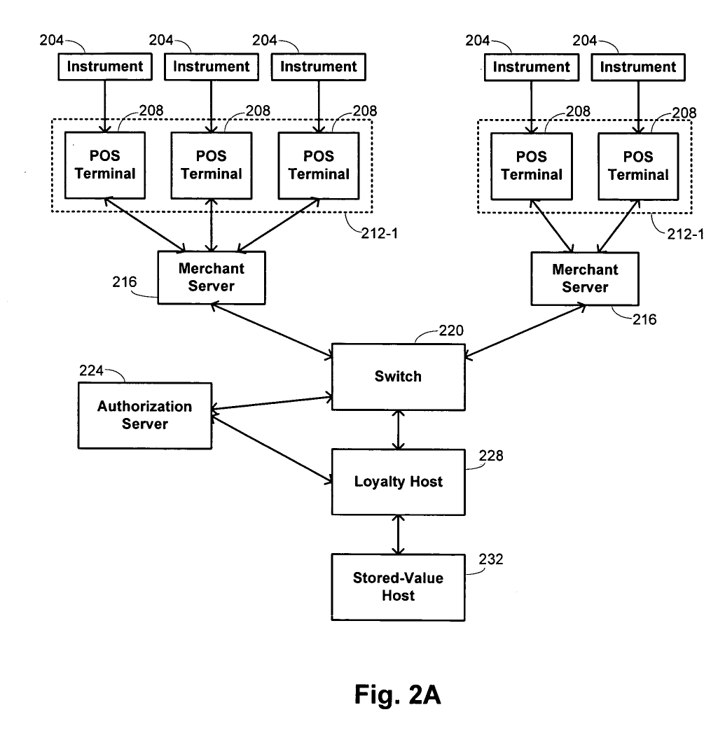

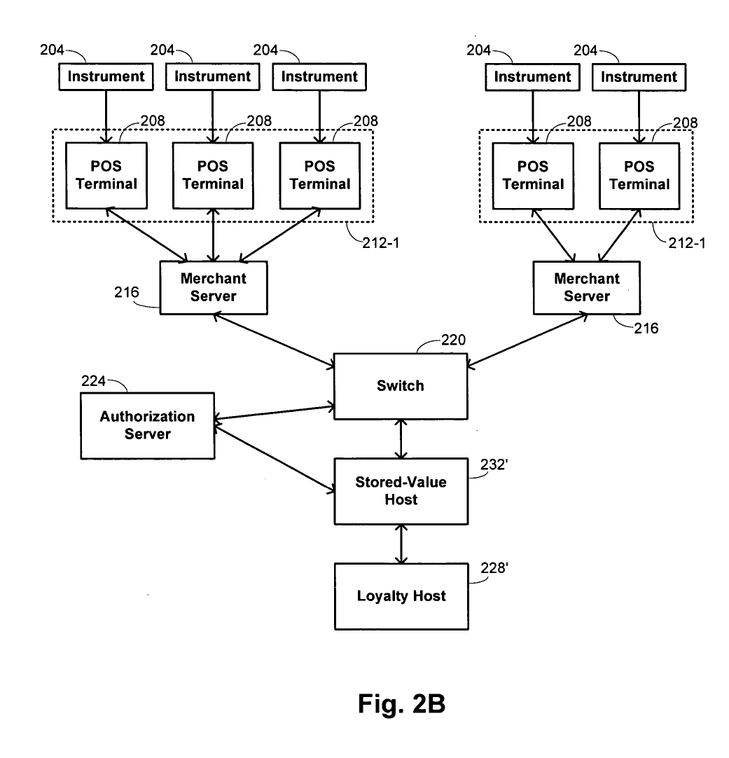

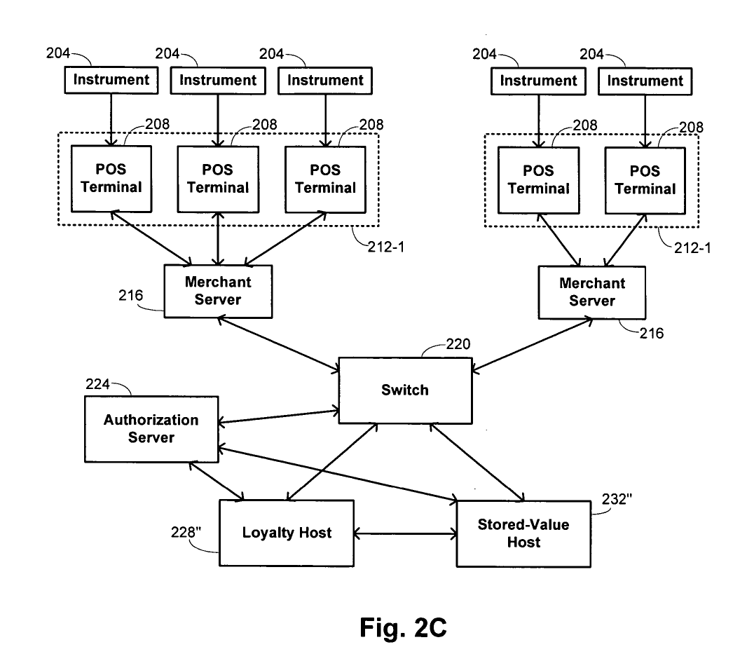

Referring now to FIGS. 2A-2C schematic overviews of integrated stored-value and loyalty systems operating on a financial infrastructures are shown. The structural arrangements shown in each of FIGS. 2A-2C are similar, although they differ in the manner in which communications are coordinated between hosts for the loyalty and stored-value systems. In particular, in each arrangement, a plurality of merchant servers 216 are provided in communication with a switching element 220 that coordinates transmission of communications within the integrated infrastructure. Each merchant server 216 is in communication with one or more point-of-sale terminals, which may be widely distributed geographically and which may be associated with a variety of different types of organizations, including retail outlets, services outlets, and the like. Each point-of-sale terminal 208 may be configured to accept one or more different types of instruments 204, such as a magnetic-stripe card 202 (including a credit, debit, or other card having magnetically encoded information), a chip card such as a smart card, a coupon, a check, a radio-frequency communication, an infrared communication (e.g., IrDA) and the like. Accordingly, customers may individually control the instrument used for participation in loyalty and stored-value programs and may use different aggregator instruments at different times if desired. Furthermore, the point-of-sale device 112 may include other components that facilitate execution of a transaction, such as payment-information-entry components, signature-capture components, keypads, keyboards, display screens, biometric-data-capture components, speakers, printers, processors, software, memory, communication devices, and the like. Examples of suitable point-of-sale devices that include multiple capabilities are provided in the following commonly assigned applications, the entire disclosures of which are incorporated herein by reference for all purposes: U.S. Prov. Pat. Appl. No. 60/147,889, entitled “INTEGRATED POINT OF SALE DEVICE,” filed Aug. 9, 1999 by Randy J. Templeton et al.; U.S. patent application Ser. No. 09/634,901, entitled “POINT OF SALE PAYMENT SYSTEM,” filed Aug. 9, 2000 by Randy J. Templeton et al.; U.S. patent application Ser. No. 10/116,689, entitled “SYSTEMS AND METHODS FOR PERFORMING TRANSACTIONS AT A POINT-OF-SALE,” filed Apr. 3, 2002 by Earney Stoutenburg et al.; U.S. patent application Ser. No. 10/116,733, entitled “SYSTEMS AND METHODS FOR DEPLOYING A POINT-OF-SALE SYSTEM,” filed Apr. 3, 2002 by Earney Stoutenburg et al.; U.S. patent application Ser. No. 10/116,686, entitled “SYSTEMS AND METHODS FOR UTILIZING A POINT-OF-SALE SYSTEM,” filed Apr. 3, 2002 by Earney Stoutenburg et al.; and U.S. patent application Ser. No. 10/116,735, entitled “SYSTEMS AND METHODS FOR CONFIGURING A POINT-OF-SALE SYSTEM,” filed Apr. 3, 2002 by Earney Stoutenburg.

When a transaction is executed using a point-of-sale terminal 208, an electronic packet identifying the terms of the transaction, including an identification of a payment instrument, a stored-value-programidentifier, and/or a loyalty-programidentifier, is forwarded by the corresponding merchant server 216 to the switching element 220. The specific components of the electronic packet may vary in different circumstances since some transactions may be made without identifying a stored-value program and/or without identifying a loyalty program. Also, as described in additional detail below, the electronic packet may include item-level detail specifying each product that forms part of the transaction to be used in implementing certain loyalty programs that make use of such information. The manner in which the switching element 220 routes all or part of the electronic packet may depend on how it is physically connected with other parts of the integrated infrastructure. For example, in FIG. 2A, the switching element 220 includes a connection with an authorization server 224 and with a loyalty host 228 that is configured to manage the loyalty program. The loyalty host 228 is in communication with a stored-value host 232 that is configured to manage the stored-value program.

The switching element 220 initially makes a determination whether the merchant and customer who are parties to the transaction are registered with either or both of the loyalty system and stored-value system. Such a comparison is performed by comparing the identification of the parties included within the electronic packet with a database listing of registered participants. If either party is not registered, the switching element 220 only forwards the electronic packet to the authorization server 224 through communication networks comprised by the financial infrastructure. Such a routing may be appropriate, for example, where a transaction is initiated using a credit or debit card at a merchant that does not honor applicable stored-value or loyalty programs or by a customer who is not enrolled in such programs. Irrespective of how it is implemented, the authorization server 224 may subsequently return an approval or denial code for the transaction depending on a result of applying approval standards. The approval or denial code may then be routed back to the point-of-sale terminal 208 through the switching element 220 and merchant server 216.

In other embodiments, the functions of authorization server 224 may be incorporated into the stored-value host 232 and/or the loyalty host 228. This eliminates the need for routing electronic packets with the identification of the parties to a separate authorization server 224, and the authorization server 224 may be eliminated from the system. For example, in the transaction described above, the approval or denial code for the transaction may be decided directly at the stored-value host 232 by applying approval standards incorporated into the host. The approval or denial code (along with other information) may then be routed from the stored-value host 232 to the point-of-sale terminal 208 through the switching element 220 and merchant server 216.

If the parties to the transaction are registered, indicating that the customer is participating in one or more forms of loyalty programs and/or is participating in a stored-value program, the switching element 220 forwards at least relevant portions of the electronic packet to the loyalty host 228. In alternate embodiments, a closed loop network may be used to connect the elements of the system (e.g., stored-value host 232, loyalty host 228, POS terminal 208) eliminating the need for switching element 220 to route portions of the electronic packet. The loyalty host 228 stores administration criteria for the loyalty programs and includes protocols for further forwarding relevant portions of the electronic packet to the stored-value host 232 as needed. The administration criteria for the loyalty programs may be applied in accordance with a variety of different schemes, some of which are described below, and such administration may include routing data back to a point-of-sale terminal 208 through the switching element 220 and a merchant server 216. The stored-value host 232 stores administration criteria for the stored-value programs and may route information back to a point-of-sale terminal 208 through the loyalty host 228, switching element 220, and merchant server 216.

FIG. 2B illustrates an alternative embodiment in which the logical positions of the loyalty host 228 and stored-value host 232, now denoted with primes as loyalty host 228′ and stored-value host 232′, are interchanged. The operation of this architectural arrangement is similar to that described in connection with FIG. 2A, but with this configuration, the electronic packet is routed first to the stored-value host 232′ and then subsequently to the loyalty host 228′. The stored-value host 232′ then stores administration criteria for the stored-value programs and includes protocols for further forwarding relevant portions of the electronic packet to the loyalty host 228′, which includes a store of administration criteria for the loyalty programs. Data routed back to a point-of-sale terminal 208 as part of implementing the loyalty and/or stored-value programs may be routed through the switching element 220 and a merchant server 216, in addition to through the stored-value host 232′ in the case of the loyalty programs.

FIG. 2C illustrates a further embodiment in which data routing to the loyalty host 228″ and stored-value host 232″, denoted with double primes, may be performed in parallel rather than serially. In particular, in this instance, communications links exist between the switching element 220 and loyalty host 228″ that do not require routing through the stored-value host 232″ and similarly between the switching element 220 and stored-value host 232″ that do not require routing through the loyalty host 228″. In such an embodiment, each of the stored-value and loyalty hosts 228″ and 232″ stores respective sets of administration criteria and may route data back through the switching element 220 and a merchant server 216 to a point-of-sale terminal 208 as appropriate in some embodiments.

In the architectures illustrated with FIGS. 2B and 2C, the switching element is additionally shown equipped to forward the electronic packet to the authorization authority 224, as was mentioned in connection with FIG. 2A. In some alternative embodiments, this function may alternatively be performed by the loyalty host or stored-value host over corresponding communication links. Such a capacity may be used, for example, in embodiments where application of the loyalty and/or stored-value programs is to be implemented only if the transaction is properly authorized and executed.

The structure of FIGS. 2A-2C is also intended to illustrate that information regarding the loyalty and stored-value programs may be obtained from multiple merchants. In some embodiments, these multiple merchants may define a coalition that acts in concert in implementing loyalty and/or stored-value programs. For example, such a coalition might include at least one merchant from different market segments to enhance an overall customer experience and provide greater versatility in the loyalty programs. This greater versatility may be reflected, for example, by offering rewards in one market segment that result from customer activity in a different market segment. This cooperation among merchants thus benefits customers by significantly expanding the scope of the potential loyalty rewards and also acts to the benefit of merchants by inducing customers to participate in particular ways in other market segments.

Stored-Value and Loyalty Programs

In embodiments of the invention, stored-value programs may be implemented by using one or more stored-value parameters. These stored-value parameters may, for example, hold information related directly to aspects of a purchasing history by customers, with the actual currency value being correlated to the stored-value parameters by a particular algorithm. Such an arrangement provides considerably greater flexibility in the way in which value indicators may be stored when compared with simply storing cash-value amounts, and permits a more flexible integration with the loyalty programs. In some instances, maintaining stored-value parameters in lieu of cash-value amounts permits the implementation of loyalty programs that would not possible with an integration with a cash-value stored-value program.

The specific nature of the stored-value parameters may vary in different instances, and may be used to accumulate such information as the number of times purchases have been made at a particular location, the number of times particular products or classes of products have been purchased, the number of times certain value constraints have been met by individual purchases, and the like. These and other types of loyalty information may be easily aggregated by loyalty activity and subsequently be converted to cash value when the stored-value program is implemented. In some cases, a reverse conversion may be used when value is added to a stored-value program with cash or equivalent value. The use of a surrogate conveniently allows the implementation of nonlinear translations between the values that are stored and their corresponding cash values. For instance, points could be distributed so that 1.0 point is assigned for each dollar of value up to $25, 1.2 points are assigned for each dollar of value between $26 and $50, 1.5 points are assigned for each dollar of value between $51 and $100, 1.8 points are assigned for each dollar of value between $101 and $500, etc. Similar nonlinear translations may be used in redeeming the value, and different translation algorithms may be used for purchasing and redeeming value to accommodate specific types of arrangements. Furthermore, the reverse translation capabilities may be used in some instances to accelerate qualifications for certain rewards through the stored-value mechanisms. For example, a point threshold may established for automatically translating points to a cash value added to a stored-value account when a predetermined number of points are accrued. Parameters may be set to allow the conversion a predetermined number of times (e.g., one time, five times, etc.), or to allow the conversion on a continuing basis each time the point threshold is reached. In another example, a predetermined number of points may be periodically converted into a cash value added to the stored-value account on a recurring date (e.g., weekly, monthly, annually, etc.). Remaining points that not translated into a cash value on the recurring date may be carried over to the next translation period, or cancelled (i.e., use them or lose them).

Some examples of the interplay between the stored-value and loyalty aspects of the integrated arrangement are discussed with a number of examples in greater detail below. Still more complex algorithms may be used in the value translations by making use of more than one type of value. For example, determination of a cash amount may depend on multiple parameters that store different types of information.

Additional types of loyalty information that may be used to determine customer rewards may include the value of the transaction as described above, and may also include transaction recency information (e.g., customer purchases a threshold number (or more) of goods or services from a merchant during a specified window of time), transaction frequency information (e.g., customer meets or exceeds a threshold purchasing rate, such as 10 purchases/month), transaction SKU information (e.g., if customer buys a item associated with a certain SKU number he gets a customer reward), transaction surprise information (e.g., a customer receives an unpredictable customer reward), transaction day-of-the-week information (e.g., customer receives a customer reward for making a purchase on a specified day (or days) of the week), transaction time-of-day information (e.g., customer receives a customer reward for making a purchase during a specified time of day), customer birthday/anniversary information (e.g., customer receives a customer reward on birthday or annual anniversaries of participating in the loyalty program), stored-value account initiation information (e.g., customer receives a customer reward for purchasing a stored-value card or subscribing to a loyalty program), and account replenishment information (e.g., customer receives a customer reward for adding additional value to the stored-value account), among other types of loyalty information used to determine a customer reward.

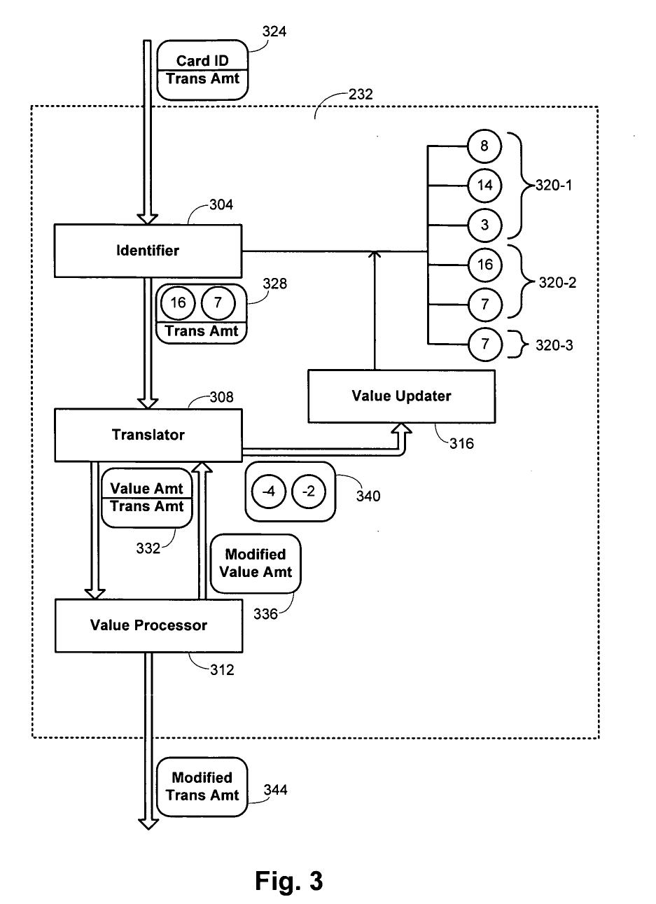

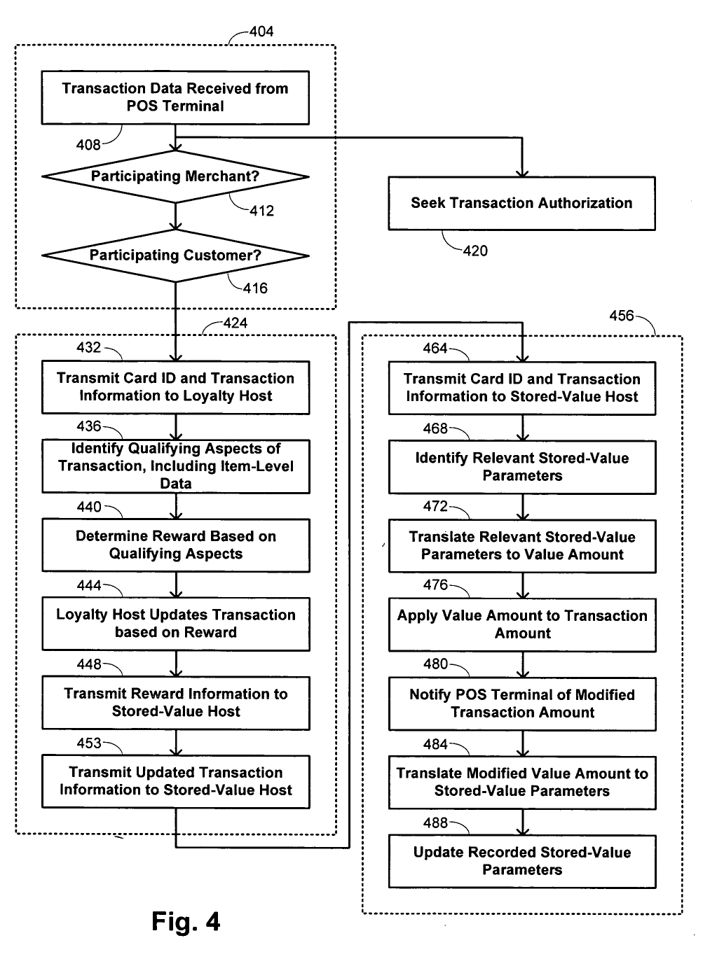

FIG. 3 provides an illustration of a logical structure that may be used by the stored-value host 232 to store and perform translations in order to maintain value records and to effect use of the corresponding value. This logical structure includes a number of modules, including an identifier 304, a translator 308, a value updater 316, and a value processor 312, each of which may be implemented as software in an appropriate hardware computational device. When a request is received for use of some of the stored value for a particular customer, an electronic packet 324 may be received that includes a card identifier and a transaction amount. These values may have been generated, for example, by the point-of-sale terminal 208 as part of a transaction and routed through any of the architectures shown in FIGS. 2A-2C to arrive at the stored-value host 232. The card identifier provides a unique identification of one or more stored-value accounts; while it is described herein for convenience as a card identifier used to identify a stored-value card presented during a transaction, it will be appreciated that the identifier may apply more generally to identify the stored-value accounts and does not require the use of a card.

The different accounts that may be maintained are illustrated schematically in the figure with circles that enclose certain point values. Each card identification may identify one or more of the accounts, as indicated by sets 320. The card identification is thus used by the identifier module 304 to identify which stored-value accounts are to be considered in the value translation. In the example, the accounts identified by set 320-2 are used so that an intermediate electronic packet 328 may be generated in which the card identification is substituted with the point values for those accounts. This intermediate electronic packet 328 is used by the translator module 308 to convert the point values into a cash value amount, as indicated in electronic packet 332. Such a translation is performed in accordance with the specified algorithms and may differ for a number of different reasons. For example, the stored-value host 232 may be intended to handle a number of different stored-value programs, perhaps for a variety of different merchants, merchant associations, and/or issuer associations, and each of those programs may treat the translations in a different fashion.

The value processor module 312 determines how the stored value is to be applied to the transaction amount, producing electronic packets that define a modified transaction amount 344 and a modified value amount 336 depending on that application. In a relatively simple embodiment, this may be preformed simply by comparing the size of the value amount with the transaction amount in electronic packet 332. If the value amount is greater than the transaction amount, the modified transaction amount 344 may be reduced to zero and the modified value amount 336 set equal to the difference between the original value amount and the original transaction amount. If the transaction amount is instead greater than the value amount, the modified transaction amount 344 may be set equal to the difference between the original transaction amount and the original value amount while the modified value amount is set to zero. In other embodiments, other types of manipulations may be performed in assigning the modified value and transaction amounts 344 and 336, perhaps taking into account standing instructions regarding such manipulations provided by the customer or specific instructions that may be provided by the customer at the point of sale. Such alternative manipulations may be designed to deplete certain types of value parameters preferentially over others.

The modified value amount 336 is returned to the translator module 308 for translation back into the stored-value parameters to update those values in accordance with the execution of the transaction. An electronic packet 340 that defines how the value parameters are to change is therefore transmitted to the value updater module 316, which changes the value parameters as indicated.

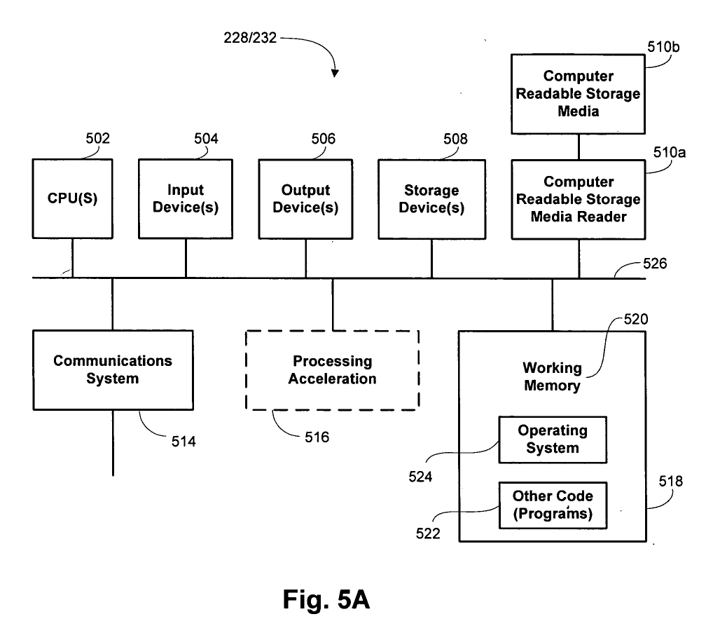

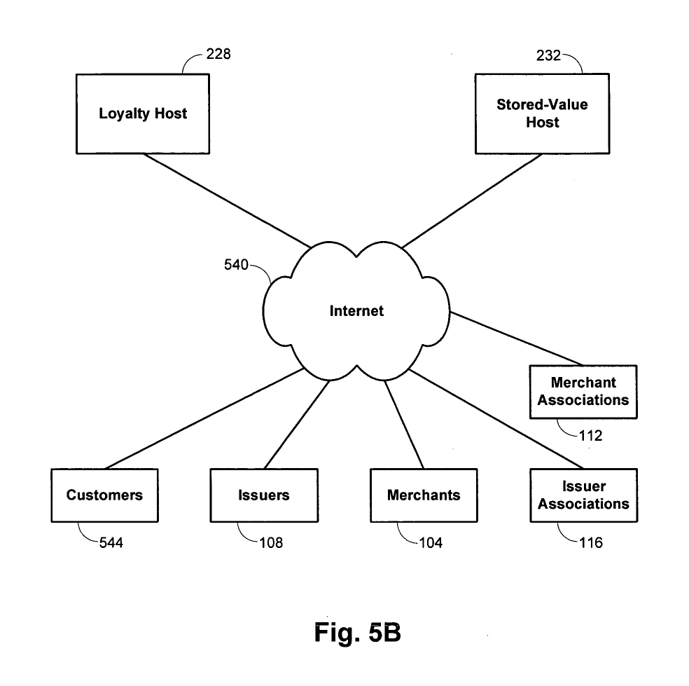

The coordinated operation of the switching element 220, loyalty host 228, and/or stored-value host 232 with respect to a transaction is illustrated with the flow diagram of FIG. 5 for one embodiment. Those functions performed by the switching element 220 are denoted generally by block 404, those performed by the loyalty host 228 are denoted generally by block 424, and those performed by the stored-value host 232 are denoted generally by block 456. The progression through the flow diagram is shown for an embodiment that uses the architecture described in connection with FIG. 2A, with loyalty-host functions being performed in block 424 after switching-element functions in block 404 and before stored-value-host functions in block 456. In alternative architectures, the progression through the flow diagram may differ. For example, with the architecture described in connection with FIG. 2B, the flow may proceed from block 404 to block 456 and then to block 424; alternatively, with the architecture described in connection with FIG. 2C, the flow may proceed in parallel from block 404 to blocks 424 and 456. Moreover, there is no requirement that the functions represented by the individual blocks be performed in the order indicated. In some alternative embodiments, the functions may be performed in a different order, some functions may be omitted, and some additional functions may be added.

At block 408, transaction data are received from the point-of-sale terminal 208 as an electronic packet by the switching element 220. The item-level transaction information that may be included in that electronic packet may be obtained at the point-of-sale terminal by reading bar-code information printed directly on an item or an affixed label. The identification by the point-of-sale device 208 is generally sufficient to identify both the price of each item as well as to provide a classification of each item. In embodiments that use bar codes, for example, classification may be deduced from the bar code in accordance with standardized classification systems, including, for example, the Universal Product Code (“UPC”) system, the European Article Number (“EAN”) system, the Global Trade Item Number (“GTIN”) system, the Serialized Shipping Container Code (“SSCC”) system, the Global Location Number (“GLN”) system, the Global Returnable Asset Identifier (“GRAI”) system, the Global Individual Asset Identifier (“GIAI”) system, and the Global Service Relation Number (“GSRN”) system, among others. Many of these systems are currently administered by the Uniform Code Council, Inc. (“UCC”) and EAN International. While the emphasis of the these organizations is currently on bar-code technologies, including Reduced Space Symbology (“RSS”) and Composite Symbology (“CS”), they acknowledge that the systems may alternatively be implemented using other technologies, such as with radio-frequency tags. Embodiments of the invention are not restricted to any particular classification technology and are intended to encompass all such classification systems.

The transaction information may be used as indicated at block 420 to seek authorization for the transaction. At block 412, the electronic packet is analyzed to identify the merchant at which the transaction originated and to determine whether that merchant participates in any of the loyalty and/or stored-value programs administered by the loyalty and/or stored-value hosts 228 and 232. Similarly, the electronic packet is analyzed at block 416 to determine whether the customer who is a party to the transaction participates in the loyalty and/or stored-value programs. If the merchant or customer does not participate, the transaction-authorization process may proceed but neither the loyalty nor stored-value programs are implemented.

If loyalty functions are to be invoked, the card identification and transaction information are transmitted to the loyalty host 228 at block 428. Aspects of the transaction that qualify for loyalty reward are identified from the transaction data, including identification of item-level data that may define qualifying aspects of the transaction, at block 436. These qualifying aspects are used to determine whether a reward should be issued at block 440. Usually such a determination is made on a combination of aspects of the current transaction with recorded past behavior, although in some instances a single transaction may qualify for a reward. If there has been no qualification for a reward, the qualifying aspects of the transaction may be accumulated with the records of prior transactions so that a similar determination whether a reward has been earned may be made with data from a subsequent transaction.

If a reward has been earned, there are multiple ways in which the reward may be provided to the customer in different embodiments. For instance, in one embodiment, the reward is used by the loyalty host to update aspects of the transaction at step 444. The reward information may also be separately transmitted to the stored-value host at step 448, and the updated transaction information may be transferred to the stored-value host at step 453. In some embodiments, the transmission of the reward information to the stored-value host may be combined with the updated transaction information, and in other embodiments the reward information may not be transmitted.

In yet other embodiments (not shown) reward information may be provided by transmitting an award notification back to the point-of-sale terminal 208. The reward information may result in the printing of a certificate or notification of the award by the point-of-sale terminal 208 rather than resulting in an immediate application of the reward. Such embodiments may be suitable when the reward applies to a different merchant or class of merchants who participate in a coalition-based loyalty program. For instance, a customer might make purchases at merchant X, a clothing retailer, which qualifies her for a reward that is equal to 100 points in a stored-value account that is restricted to redemption at merchant Y, a hardware retailer. Accordingly, the customer is notified of the reward through the point-of-sale terminal 208 at the time of the purchase at merchant X, and the loyalty host 228 automatically credits the stored-value account with the reward equal to 100 points.

If the stored-value functions are to be invoked, the card identification and transaction information are transmitted to the stored-value host 232 at block 464. The transaction information includes at least the total transaction amount and may also include subamounts that correspond to particular types of items that form part of the transaction. Relevant stored-value parameters are identified at block 468 as described above by identifying which stored-value accounts correspond to the received card identification and perhaps also correspond to the accounts that are limited to use at the particular merchant or for a particular product type. The stored-value parameters are translated to a value amount at block 472, such as by using the translator module 308 described in connection with FIG. 3. At block 476, the value amount is applied to the transaction to determine a modified transaction amount and a modified value amount. These values are usually reduced by the same amount from the original transaction and value amounts, although there may be instances in which the reductions differ. The point-of-sale terminal is notified of the modified transaction amount at block 480 so that that amount may be substituted for the original transaction amount in executing the transaction. In addition, the modified value amount is translated to the stored-value parameters at block 484 so that the recorded stored-value parameters may be updated at block 488.

In the foregoing description, identification of the item-level data in administering the loyalty programs was described as being performed at the loyalty host 228. In other embodiments, however, such item-level information may alternatively be processed at a different point in the architecture. In one such embodiment, the item-level information is processed at the point-of-sale terminal 208 where the transaction is initiated. In this embodiment each point-of-sale terminal 208 includes a copy of item-level qualifications for the loyalty programs so that those parts of the transaction that qualify may be identified at the outset. Rather than transmit specific item-level information as part of the electronic packet to the switching element 220, the electronic packet may instead simply identify that certain qualifications for certain loyalty programs have been met. Such an embodiment simplifies the operation of the loyalty host 228, but requires that data specifying administration of the loyalty programs be maintained on multiple point-of-sale devices 208. In another embodiment, these two considerations may be compromised by maintaining the item-level loyalty-program information on the merchant servers 216 and performing the identification of met qualifications at those points in the architecture.

Each of the loyalty host 228 and stored-value host 232 may be configured in a variety of different ways to effect the functions described. In one embodiment, a computer system is used for each, one example of which is shown schematically in FIG. 5A. This figure broadly illustrates how individual system elements for the loyalty host 228 or stored-value host 232 may be implemented in a separated or more integrated manner. The loyalty host 216 or stored-value host 232 is shown comprised of hardware elements that are electrically coupled via bus 508, including a processor 502, one or more input devices 504, one or more output devices 508, one or more storage devices 508, a computer-readable storage media reader 510a, a communications system 514, a processing acceleration unit 516 such as a DSP or special-purpose processor, and a memory 518. The computer-readable storage media reader 510a is further connected to a computer-readable storage medium 510b, the combination comprehensively representing remote, local, fixed, and/or removable storage devices plus storage media for temporarily and/or more permanently containing computer-readable information.

Information regarding merchants, issuers, individual customers and details specifying the administration of the loyalty and/or stored-value programs is generally stored on the storage devices 508. The communications system 514 is configured to effect communications as needed by receiving the electronic packet from the switching element 220 and to provide return communications back through the infrastructure. In addition to providing such infrastructure communications links internal to the system, the communications system 514 may also provide a connection to other networks such as the Internet and may comprise a wired, wireless, modem, and/or other type of interfacing connection. Such additional connections may be useful for support functions that may be assisted by the loyalty host 228 and/or stored-value host 232 described briefly below.

The loyalty host 228 or stored-value host 232 also comprises software elements, shown as being currently located within working memory 520, including an operating system 524 and other code 522, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

FIG. 5B provides a schematic illustration of one embodiment in which the loyalty host 228 and the stored-value host 232 are connected with the Internet 540 to provide support services to merchants 104, issuers 108, merchant associations 112, issuer associations 116, and/or customers 544. In additional to managing transactions for loyalty and/or stored-value credit, the respective hosts 228 and 232 may be configured to assist in supplementary service functions able to exploit the fact that the hosts 228 and 232 are equipped to maintain database information for the participating merchants 104, issuers 108, merchant associations 112, issuer associations 116, and/or customers 544. Accommodation of such support services over an Internet connection is in addition to the use of infrastructure connections described with respect to FIGS. 2A-2C and intended for services that are not as time critical as the loyalty, stored-value, and authorization decisions needed at the time of a transaction.

Examples of support services that may be configured in this way include card-creation services, customer-care services, and settlement services, in addition to other support services. Such services may be provided as functions comprised by the hosts 228 and 232 or may be provided as functions operating separately but with access to the hosts. Elements for providing the support services thus usually include a communication with the Internet 540 so that their functions may be accessed as necessary or desirable by merchants 104, issuers 108, merchant associations 112, issuer associations 116, and/or customers 544.

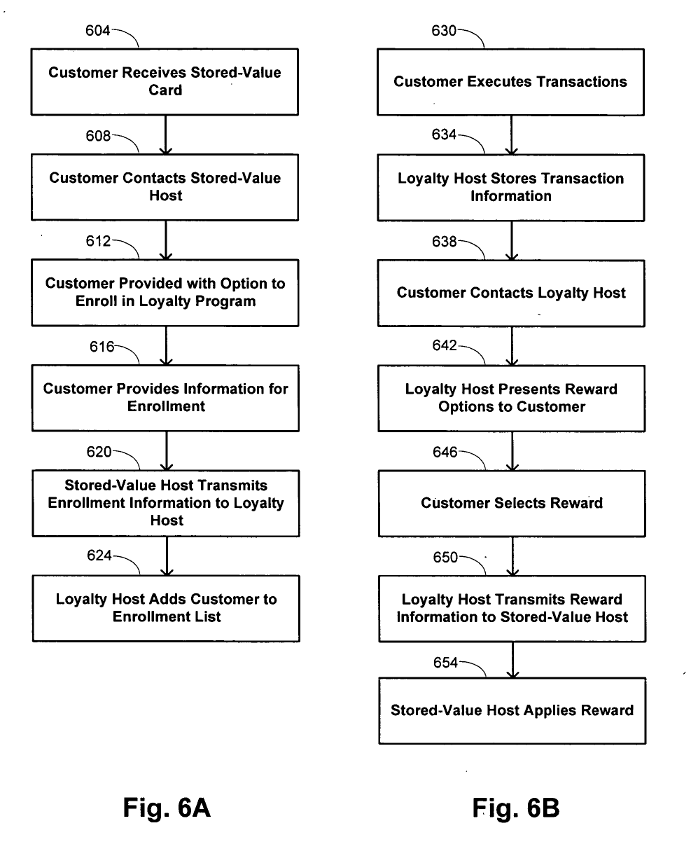

FIGS. 6A and 6B use flow diagrams to provide examples of program-management functions that may be implemented with the integrated loyalty and stored-value systems. FIG. 6A illustrates how a recipient of a stored-value card may enroll in a corresponding loyalty program, such as when a customer receives a stored-value card as indicated at block 604. Often, stored-value cards are provided to recipients in the form of gift cards, which are preloaded with a certain value. In cases where the integration with a loyalty program is promoted, the stored-value card may have contact information printed on the card to encourage the recipient to enroll in that loyalty program and/or a message printed on the recipients receipt stating how to enroll in the loyalty program. Thus, at block 608, the customer may contact the Loyalty host, usually by using the Internet connection shown in FIG. 5B, but perhaps alternatively with a telephone interface, through a customer-service representative, or in some other fashion. In response to an option provided to the customer at block 612 to enroll in the loyalty program, the customer provides suitable enrollment information at block 616. Thereafter, the customer may participate in the loyalty-program aspects provided by the system in addition to participating in the stored-value aspects.

In some instances, the experience of the customer may be enhanced by providing the customer with the ability to choose a reward from among a number of options, rather than simply providing a default award based on transaction activity. One method of providing such options is illustrated in FIG. 6B. In response to execution of various transactions at block 630, the loyalty host stores and accumulates transaction information at block 634 to monitor the customer's progress towards a reward. In some cases, different rewards may be provided at different levels, with the customer being required to forego a lower-level reward to accumulate more transactions to qualify for the higher-level reward. When the customer contacts the loyalty host at block 638, such as over the Internet connection shown in FIG. 5B or through another mechanism, the loyalty host presents a number of reward options to the customer at block 642 from which the customer may make a selection at block 646. In response to the customer's selection, the loyalty host transmits reward information to the stored-value host at block 650 so that the stored-value host may apply the reward at block 654.

### EXAMPLES

The systems described above are suitable for accommodating a large variety of different types of loyalty programs, and for integrating those programs with stored-value programs. Individual programs may be specific to an individual store or organization or may span across multiple otherwise unrelated organizations as part of a more comprehensive coalition-based loyalty system. In one aspect, individual customers may participate in multiple loyalty programs that are managed as independent programs by the aggregator 118. Points maintained for the different programs are identified and distinguished by different point types. In this way, the customer may be able to use a single instrument identified with the aggregator's logo for participation in all its loyalty programs.

For each of the loyalty programs, rewards may be accumulated in at least three ways. First, rewards may be based on recency criteria, in which a reward is triggered either by completing a transaction within a specified time interval or by completing a specified number of transactions within a given time interval. Second, rewards may be based on frequency, in which a reward is triggered by completing a specified number of transactions. Third, rewards may be monetarily based so that a reward is triggered when a specified total transaction amount is reached. Such triggers may be specified for individual transactions or may be specified for accumulated transaction amounts over multiple transactions.

In addition, reward triggers may be conditional. Examples of conditional triggers include a requirement that points be accumulated only for transaction above a certain amount, and perhaps that points be accumulated more generally at different rates for transactions of different sizes. Other conditional triggers may be associated with time constraints so that points may only be accumulated only after a specified date, only before a specified date, only on certain days of the week, only during certain holiday periods, etc. Accumulation of points may also be conditionally restricted to certain tender types and to transactions where no reward is applied.

Accumulation of rewards is generally tracked in terms of points, which may be correlated with aspects of a transaction, and may be set to expire after a certain time period or at a predetermined time. Thus, for a recency loyalty system, points will generally be set to expire within the time period required for completion of the transactions. For a frequency loyalty system, points will usually be integers corresponding to the number of transactions completed. For a monetary loyalty system, points will be correlated with the dollar amount of the transaction, perhaps nonlinearly if customers are to be credited differently based on the size of individual transactions. The correlation rates may differ for different issuers, even within the same loyalty program, requiring use of the settlement functions among issuers and/or merchants. Points may generally be structured to expire periodically or after a specified period of inactivity to prevent excess accumulation by individual customers. Furthermore, point totals for individuals may be conditioned to reset when awards are given, to reset on a cyclical basis (e.g., monthly or annually), to continue to accumulate (rewards given for different levels reached), or to be permanently eliminated upon issuance of a reward (such as for a one-time reward).

In certain embodiments, points may be accumulated collectively by multiple customers. For example, each member of a family may have a separate card that identifies them individually, but points are accumulated into an account for the family as a whole. In other embodiments, points may be transferred among customers.

The manner in which such loyalty programs function may be illustrated with specific examples. First, consider a coalition-based loyalty program in which points are given for every dollar spent at any of a plurality of stores having diverse retail practices, such as a clothing chain, a hardware chain, and a restaurant chain. A customer who uses a card bearing a logo for the aggregator that manages this program accumulates points at any of the stores and may exchange the accumulated points for goods at any of the stores. For example, the customer may make a series of purchases at the hardware chain over a period of time and may subsequently redeem the points for dinner at a restaurant that forms part of the restaurant chain. This is an example of a purely monetary loyalty program that operates by the individual chains determining how to allocate point values among themselves to accommodate their respective benefits of participating in the program. This is also an example where different money-point correlation rates may be appropriate to account for differences in retail practices among the merchants.

As another example, consider a loyalty program in which a pizza chain and a video-rental chain cooperate. They advertise collectively that anyone who buys three pizzas at the pizza chain may receive a free video rental at the video-rental chain and anyone who rents fifteen videos at the video-rental chain is entitled to a free pizza at the pizza chain. Customers having cards bearing the aggregator logo have their purchases of pizzas and rentals of videos recorded so that the reward may be issued when the criteria have been fulfilled. Such rewards may be given automatically at the point of sale when the customer uses his card. This is an example of a frequency-based reward system that uses the aggregator to integrate separate organizations into the plan in a cooperative way.

As a further example, consider a loyalty program in which a movie-theater chain, a bookstore chain, and a music-store chain that are otherwise independent from one another cooperate. They offer a program in which, in any monthly period, a $25.00 purchase at each of two of the chains entitles the customer to a $5.00 rebate towards a purchase at the third chain. The purchases of customers having cards bearing the aggregator logo are recorded whenever they visit any of the three chains and issue the appropriate reward when the conditions are met. This example combines aspects of recency-based and monetary-based loyalty systems that use the aggregator to permit separate organizations to cooperate to their mutual benefit.

In each of these examples, the customer may be provided with a significantly more diverse array of options when the loyalty program is coupled with the stored-value program. In particular, in some embodiments the customer may be permitted to exercise greater control over how accumulating points are used by storing the loyalty points as value parameters used by the stored-value system. In such embodiments, the points may be allowed to accumulate by the customer to trigger a loyalty reward, or may be used according to the value translation used by the stored-value host. Loyalty rewards may effectively be accelerated through payment by the customer, i.e. by adding stored value that translates into the desired types of value parameters.

In other instances, the reloading of value in the stored-value portion of the program may itself generate loyalty points towards a reward. For instance, a reward may be provided, say in the form of a free pizza purchase, every time five value reloads that exceed $50 are made. The rewards may vary, such as to encourage reloading larger value amounts.

Still other arrangements are enabled by embodiments of the invention, as will be evident to those of skill in the art.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. A method of transporting electronic data in a distributed computer network, the method comprising:
receiving, at a first network node, a first data packet comprising a network event identifier, a user account identifier, and network event data, wherein the user account identifier points to a location on the first network node where the user account is stored, and the network event data define an operation between a user and a network operator;
processing the network event parameters with a loyalty algorithm to generate a loyalty value parameter; and
calculating an updated account value parameter for the user account using the loyalty value parameter.

2. The method of claim 1, wherein the method comprises transmitting the first data packet to the first network node from a second network node where the network operator is located.

3. The method of claim 2, wherein the user account identifier transmitted by the second network node is received from a portable magnetic storage medium provided by the user.

4. The method of claim 1, wherein the network event parameters include a loyalty identifier used to select the loyalty algorithm to generate the loyalty value parameter.

5. The method of claim 4, wherein the method comprises transmitting the loyalty identifier to the first node from a second network node where the network operator is located.

6. The method of claim 5, wherein the second node receives the loyalty identifier from a portable magnetic storage medium provided by the user that stores said loyalty identifier.

7. The method of claim 1, wherein the method comprises receiving, at a second network node, a second data packet comprising the updated account value parameter.

8. The method of claim 7, wherein the second data packet comprises a changed account value parameter comprising a difference between the updated value parameter and an old account value parameter.

9. The method of claim 8, wherein the method comprises printing the updated value parameter and the changed value parameter with a printer in electronic communication with the second network node.

10. The method of claim 7, wherein the method comprises recording the updated value amount on a storage medium possessed held by the user.

11. The method of claim 10, wherein the storage medium comprises a chip card or a radio-frequency device.

12. The method of claim 1, wherein, prior to the operation, the user account has an account value of zero.

13. The method of claim 1, wherein the distributed computer network is part of a financial infrastructure for processing transactions between merchants and customers.

14. The method of claim 1, wherein the first network node comprises a host computer system to process stored-value and loyalty programs.

15. The method of claim 1, wherein the user is a customer, the network operator is a merchant, and the operation between the user and the network operator is a transaction between the customer and the merchant.

16. The method of claim 1, wherein the loyalty value parameter is a customer reward.

17. The method of claim 2, wherein the second network node is a point of sale device.

18. The method of claim 3, wherein the portable magnetic storage medium is a magnetic stripe card.

19. The method of claim 1, wherein the loyalty algorithm used to generate the loyalty value parameter is selected from the group consisting of a transaction amount algorithm, a transaction recency algorithm, a transaction frequency algorithm, a transaction SKU algorithm, a transaction surprise algorithm, a transaction day-of-the-week algorithm, a transaction time-of-day algorithm, a customer birthday/anniversary algorithm, an account initiation algorithm, and an account replenishment algorithm.

20. The method of claim 1, wherein the step of processing the network event parameters with the loyalty algorithm to generate the loyalty value parameter comprises calculating the loyalty value parameter based on a transaction amount and the network operator identified by the network event data.

21. The method of claim 1, wherein the step of processing the network event parameters with the loyalty algorithm to generate the loyalty value parameter comprises calculating the loyalty value parameter based on a number of user operations in a given period of time.

22. The method of claim 1, wherein the step of processing the network event parameters with the loyalty algorithm to generate the loyalty value parameter comprises calculating the loyalty value parameter based on a day of the week that the operation occurred.

23. The method of claim 1, wherein the step of processing the network event parameters with the loyalty algorithm to generate the loyalty value parameter comprises calculating the loyalty value parameter based on a time of day that the operation occurred.

24. The method of claim 1, wherein the step of processing the network event parameters with the loyalty algorithm to generate the loyalty value parameter comprises calculating the loyalty value parameter based on the user registering in a loyalty program associated with the user account.

25. The method of claim 1, wherein the step of processing the network event parameters with the loyalty algorithm to generate the loyalty value parameter comprises calculating the loyalty value parameter based on a SKU number for an item purchased in the operation.

26. The method of claim 1, wherein the step of processing the network event parameters with the loyalty algorithm to generate the loyalty value parameter comprises calculating the loyalty value parameter based on an amount of value added to the user account by the user.

27. A method for operating an integrated stored-value and loyalty program, the method comprising:
maintaining, at a host computer system, administration criteria for each of a plurality of distinct loyalty programs including the loyalty program;
receiving, at the host computer system, a transaction identifier and a packet of transaction information defining a transaction between a merchant and a customer, wherein the packet of transaction information comprises one or more account identifiers;
determining a customer reward in accordance with the packet of transaction information and with the administration criteria for the loyalty program identified by one of the account identifiers; and
updating a stored-value account, identified in the host computer system by one of the account identifiers, with information from the customer reward.

28. The method of claim 27, wherein the administration criteria for the loyalty program is identified by a stored-value account identifier.

29. The method of claim 27, wherein the host computer system identifies the stored-value account with a stored-value account identifier.

30. The method of claim 29, wherein the method comprises transmitting the transaction identifier and the stored-value account identifier to the host computer system with a point of sale device used in the transaction.

31. The method of claim 30, wherein the stored-value account identifier transmitted by the point of sale device to the host computer system is obtained from a magnetic stripe card storing said stored-value account identifier provided by the customer.

32. The method of claim 31, wherein the magnetic stripe card stores the loyalty program identifier and the point of sale device transmits said loyalty program identifier to the host computer system.

33. The method of claim 27, wherein the method comprises receiving, at a point of sale device, a description of the customer reward.

34. The method of claim 27, wherein the method comprises receiving, at a point of sale device, an updated value amount of the stored-value account based on said updating of the account with the customer reward information.

35. The method of claim 34, wherein the method comprises printing a transaction receipt comprising a transaction amount for the transaction, and the updated value amount of the stored value account.

36. The method of claim 34, wherein the method comprises recording the updated value amount on a storage medium possessed by the customer.

37. The method of claim 36, wherein the storage medium comprises a chip card or a radio-frequency device.

38. The method of claim 27, wherein, prior to the transaction, the customer has zero account value in the stored-value account.

39. The method of claim 27, wherein the loyalty information comprises item-level information that identifies specific items that form at least part of the transaction.

40. The method of claim 27, wherein said loyalty information used for the determining of the customer reward is selected from the group consisting of transaction amount information, transaction recency information, transaction frequency information, transaction SKU information, transaction surprise information, transaction day-of-the-week information, transaction time-of-day information, customer birthday/anniversary information, account initiation information, and account replenishment information.

41. The method of claim 27, wherein said step of determining the customer reward from the loyalty information comprises calculating the customer reward based on a transaction size and the merchant identified in the loyalty information.

42. The method of claim 27, wherein said step of determining the customer reward from the loyalty information comprises calculating the customer reward based on a number of customer transactions in a given period of time.

43. The method of claim 27, wherein said step of determining the customer reward from the loyalty information comprises calculating the customer reward based on a day of the week that the transaction occurred.

44. The method of claim 27, wherein said step of determining the customer reward from the loyalty information comprises calculating the customer reward based on a time of day that the transaction occurred.

45. The method of claim 27, wherein said step of determining the customer reward from the loyalty information comprises calculating the customer reward based on the customer registering in a loyalty program associated with the stored-value account.

46. The method of claim 27, wherein said step of determining the customer reward from the loyalty information comprises calculating the customer reward based on a SKU number for an item purchased in the transaction.

47. The method of claim 27, wherein said step of determining the customer reward from the loyalty information comprises calculating the customer reward based on an amount added to the stored-value account by the customer.

48. A method of conducting a transaction between a merchant and a customer using a stored-value account, the method comprising:
sending, to a transaction processing system, a transaction identifier and a packet of transaction information defining the transaction, wherein the packet of transaction information comprises loyalty information and a stored-value account identifier; and
receiving, at a point of sale device, customer reward information from the transaction processing system, wherein the customer reward information comprises a reward value for the transaction and an updated value amount of the stored-value account.

49. The method of claim 48, wherein the reward value for the transaction and the updated value amount of the stored-value account are printed on a transaction receipt given to the customer.

50. The method of claim 48, wherein the method comprises applying at least a portion of the reward value as value to the transaction.

51. The method of claim 48, wherein an account other than the stored-value account is applied toward at least a portion of value to the transaction.

52. The method of claim 48, wherein the transaction processing system comprises a stored-value host and a loyalty host.

53. The method of claim 52, wherein value amounts for the stored-value account are located at the stored-value host.

54. The method of claim 52, wherein the loyalty information is processed at the loyalty host to generate the customer reward information.

55. The method of claim 48, wherein the stored-value account is a gift card account.

56. The method of claim 48, wherein the stored-value account identifier is stored on a magnetic-stripe card possessed by the customer.
